(19) United States
(12) Patent Application Publication
(10) Pub. No.: US 2012/0033298 A1
(43) Pub. Date: Feb. 9, 2012

(54) STEREOSCOPIC IMAGE DISPLAYING METHOD

(76) Inventor: Kuan-Cheng Hsiao, Taipei County (TW)

(21) Appl. No.: 12/938,384

(22) Filed: Nov. 3, 2010

(30) Foreign Application Priority Data
Aug. 3, 2010 (TW) 099125808

(51) Int. Cl. G02B 27/22

(52) U.S. Cl. 359/462

(57) ABSTRACT

A stereoscopic image displaying method includes providing a display panel for displaying an image, the display panel having a pixel pitch, providing a parallax barrier having a first barrier region to an Nth barrier region and a first distance between the parallax barrier and the display panel, the first barrier region to the Nth barrier region respectively having a first barrier pitch to a Nth barrier pitch, providing a second distance between the display panel and an observer, and selecting a proper barrier region from the first barrier region to the Nth barrier region of the parallax barrier or adjusting the first distance according to the second distance.

### BACKGROUND OF THE INVENTION

1. Field of the Invention

The present invention is related to a stereoscopic image displaying method and a stereoscopic display device, and more particularly, to a stereoscopic image displaying method providing different viewing distances and a stereoscopic display device for different viewing distances.

2. Description of the Prior Art

Stereoscopic display technique is developed to provide two separate images individually to the left and right eyes of an observer, and thus the observer obtains a stereoscopic vision.

The conventional stereoscopic display devices can be classified into passive approach and active approach: The passive approach involves using of eyewear such as polarized glasses or shutter glasses while the active approach provides 3D images without assistance as mentioned above. Conventionally, the active approach involves techniques such as the parallax barrier.

Please refer to FIG. 1, which is a schematic drawing illustrating optical paths of a conventional stereoscopic display device employing a parallax barrier. As shown in FIG. 1, the conventional stereoscopic display device 100 includes a liquid crystal display (LCD) panel 110 and a parallax barrier 120. The LCD panel 110 provides a left eye image L and a right eye image R, and the parallax barrier 120, such as an optical grating, includes a plurality of shading regions 122 and transparent regions 124 alternately and repetitively arranged for separating the left eye image L and the right eye image R. Such that the observer can perceive the left eye image L and the right eye image R individually and obtain the 3D stereoscopic images.

It is noteworthy that the left eye image L and the right eye image R provided by the LCD panel 110 have a same pixel pitch 130, which is predetermined and fixed. Furthermore, the shading regions 122 and the transparent regions 124 of the parallax barrier 120 have the same barrier pitches 132, which are determined according to a distance 134 between the parallax barrier 120 and the LCD panel 110, an ideal viewing distance 136 between the observer and the LCD panel 110, and a distance 138 between two eyes and a center of two eyes of the observer. As shown in FIG. 1, the observer perceives the desired 3D stereoscopic images at a spot satisfied the viewing distance 136. But when the observer leaves the spot, no stereoscopic images are observed.

In other words, the conventional stereoscopic display device employing the parallax barrier provides an unchangeably fixed ideal viewing distance. When the observer has to change the real viewing distance, the real viewing distance not matching the fixed ideal viewing distance makes the observer cannot obtain the stereoscopic images. Consequently, the stereoscopic display device having the parallax barrier provides stereoscopic images in a limited space.

### SUMMARY OF THE INVENTION

Therefore the present invention provides a stereoscopic image displaying method able to provide different viewing distances and a stereoscopic display device for different viewing distances.

According to a first aspect of the present invention, a stereoscopic image displaying method is provided. The stereoscopic image displaying method includes providing a display panel having a pixel pitch for displaying an image; providing a parallax barrier having a first barrier region to an Nth barrier region and a first distance between the parallax barrier and the display panel, the first barrier region to the Nth barrier region respectively having a first barrier pitch to a Nth barrier pitch; providing a second distance between the display panel and an observer; and selecting a proper barrier region from the first barrier region to the Nth barrier region of the parallax barrier according to the second distance.

According to a second aspect of the present invention, another stereoscopic image displaying method is provided. The stereoscopic image displaying method includes providing a display panel having a pixel pitch for providing an image; providing a parallax barrier and a first distance between the parallax barrier and the display panel; providing a second distance between the display panel and an observer and a third distance between two eyes and a center of the two eyes of the observer; and adjusting the first distance according to the second distance and the third distance.

According to the stereoscopic image displaying methods provided by the present invention, different viewing distances are obtained by providing barrier regions having different barrier pitches or by providing different distances between the parallax barrier and the display panel. Therefore, when the observer increases or reduces the real viewing distance, the stereoscopic image displaying method and the stereoscopic display device provided by the present invention always provide 3D stereoscopic images of high quality.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic drawing illustrating optical paths of a conventional stereoscopic display device employing a parallax barrier;

FIG. 2 is a schematic drawing illustrating a stereoscopic image displaying method and a stereoscopic display device provided by a first preferred embodiment of the present invention;

FIGS. 3-4 are schematic drawings illustrating different optical paths of the preferred embodiment in different operations;

FIG. 5 is a schematic drawing illustrating a modification to the preferred embodiment;

FIG. 6 is a schematic drawing illustrating a stereoscopic image displaying method and a stereoscopic display device provided by a second preferred embodiment of the present invention;

FIGS. 7-8 are schematic drawings illustrating different optical paths of the preferred embodiment in different operations; and

FIGS. 9-10 are schematic drawings illustrating modifications to the preferred embodiment.

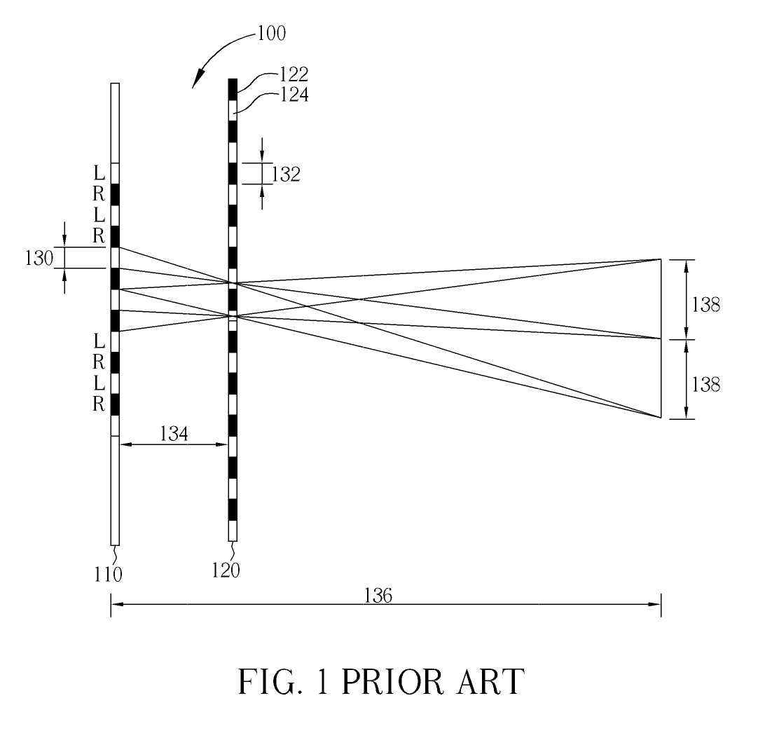

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

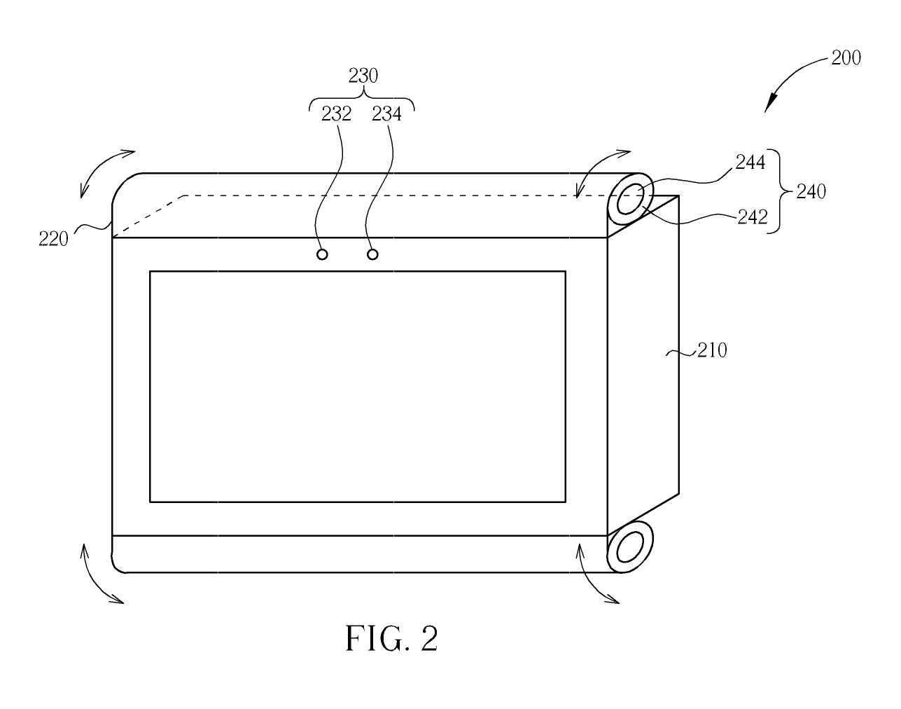

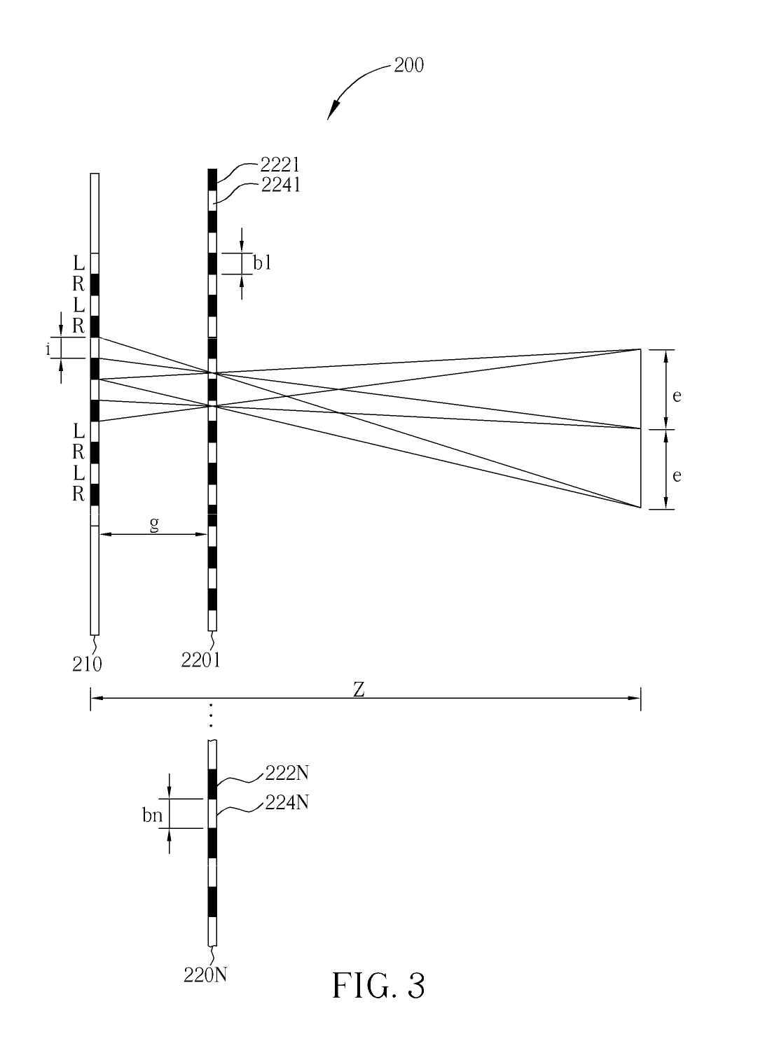

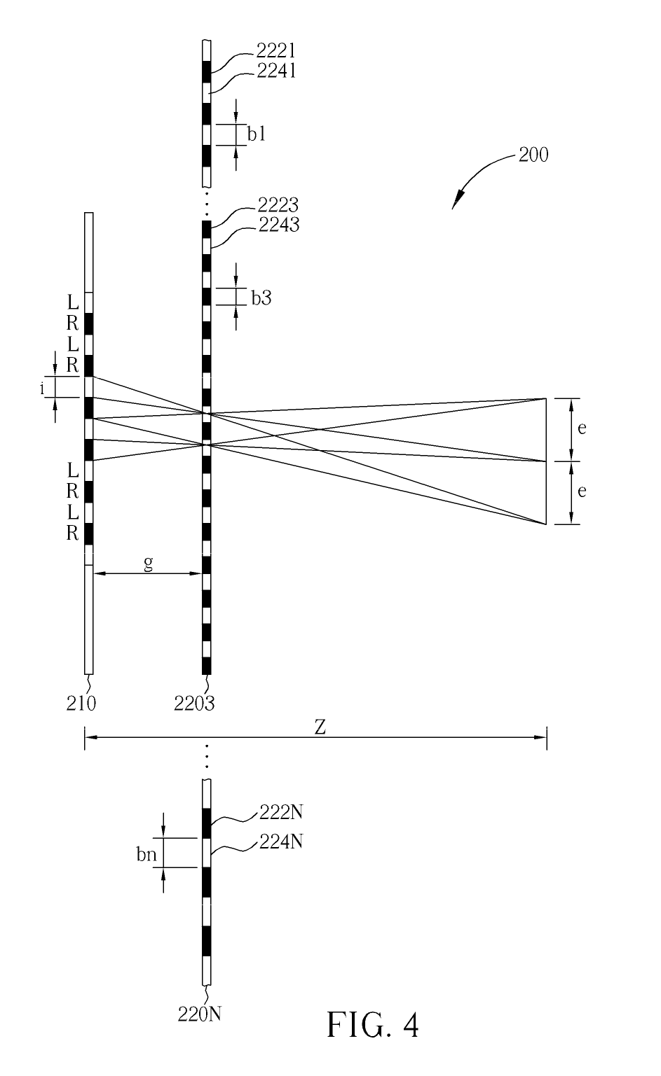

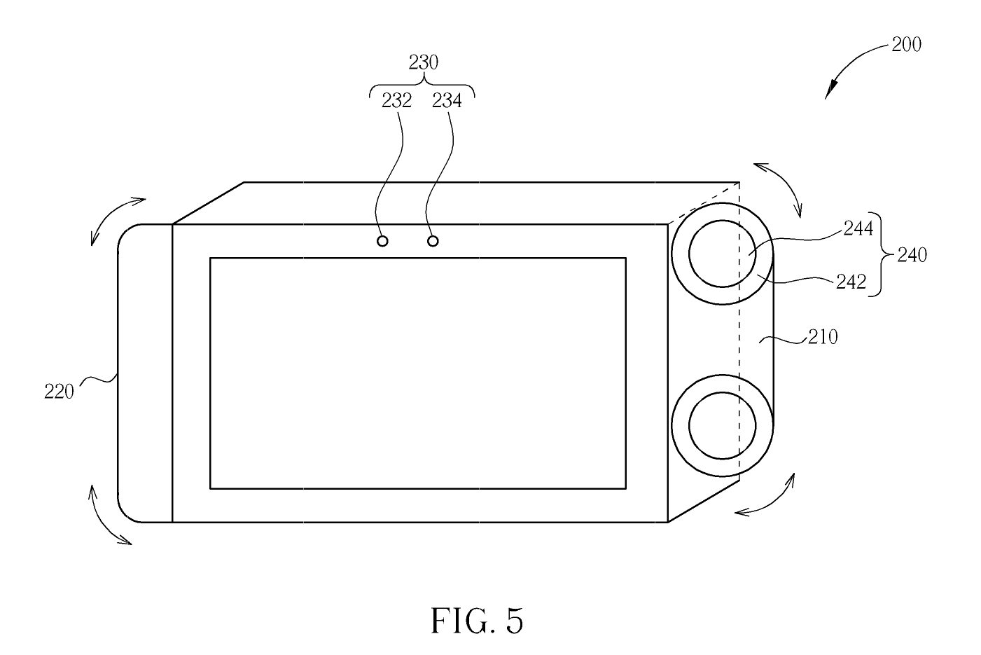

Please refer to FIGS. 2-5, wherein FIG. 2 is a schematic drawing illustrating a stereoscopic image displaying method and a stereoscopic display device provided by a first preferred embodiment of the present invention, FIGS. 3-4 are schematic drawings illustrating different optical paths of the preferred embodiment in different operations, and FIG. 5 is a schematic drawing illustrating a modification to the preferred embodiment. Please refer to FIGS. 2-4. A stereoscopic display device 200 provided by the preferred embodiment includes a display panel 210 for displaying an image. The display panel 210 can be a liquid crystal display (LCD) panel accompanied with a backlight module (not shown), but not limited to this. The image provided by the display panel 210 is divided into a left eye image L and a right eye image R (shown in FIG. 3 and FIG. 4) according to the preferred embodiment. The adjacent left eye image L and right eye image R respectively has a pixel pitch “i” formed therebetween. The stereoscopic display device 200 further includes a parallax barrier 220 and a first distance “g” between the parallax barrier 220 and the display panel 210. The parallax barrier 220 includes a first barrier region 2201 to an Nth barrier region 220N. The first barrier region 2201 has a plurality of shading regions 2221 and a plurality of transparent regions 2241. In the same concept the Nth barrier region 220N also has a plurality of shading regions 222N and a plurality of transparent regions 224N. The shading region 2221 and the transparent region 2241 of the first barrier region 2201 include a first barrier pitch b₁. In the same concept, the shading region 222N and the transparent region 224N of the Nth barrier region 220N also include a Nth barrier pitch bₙ. In other words, the shading regions 2221 and transparent regions 2241 that have strip patterns construct the first barrier region 2201 and each strip pattern has the same width, which is the first barrier pitch b₁. In the same concept, the shading regions 222N and the transparent regions 224N that have strip patterns construct the Nth barrier region 220N, and each strip pattern has the same width, that is the Nth barrier pitch bₙ. More important, the first barrier pitch b₁ to the Nth barrier pitch bₙ are different from each other. It is noteworthy that in the preferred embodiment, the parallax barrier 220 is positioned in front of the display panel 210, but it is not limited to position the parallax barrier 220 behind the display panel 210, in particularly, to position the parallax barrier 220 between the display panel 210 and the backlight module in the present invention.

Please refer to FIGS. 2-4. The stereoscopic display device 200 provided by the preferred embodiment further includes a detection-and-calculation device 230 for detecting a second distance “z”, namely the viewing distance, between the display panel 210 and an observer. The detection-and-calculation device 230 includes at least a computing circuit (not shown) and a distance meter 232. The detection-and-calculation device 230 further selectively includes an image device 234. The distance meter 232 can include an infrared distance meter or a Laser distance meter, but not limited to this. Those skilled in the art would realize that any equipment that is used to detect second distance “z” between the observer and the display panel 210 can be used. Furthermore, the stereoscopic display device 200 includes a parallax barrier adjustment device 240. The parallax barrier adjustment device 240 can include a roller 242 and a rotary stepping motor 244. The parallax barrier adjustment device 240 can be positioned on the top/bottom sides of the stereoscopic display device 200 as shown in FIG. 2; it also can be positioned on the left/right sides of the stereoscopic display device 200 as shown in FIG. 5.

According to the stereoscopic image displaying method provided by the preferred embodiment, it first provides the display panel 210 and the parallax barrier 220 as mentioned above. Then, the second distance “z” between the display panel 210 and the observer is detected by the distance meter 232 of the detection-and-calculation device 230. After obtaining the second distance “z” from the distance meter 232, the computing circuit is operated to obtain an ideal barrier pitch “bᵢ” according to a formula (1):

$$b = 2 i ( \frac{z - g}{z} ) \qquad ( 1 )$$

According to the formula (1), it is found the barrier pitch “b” is always corresponding to the second distance “z” because the pixel pitch “i” and the first distance “g” are predetermined and fixed. In other words, ideal barrier pitches bᵢ suited for different viewing distances are obtained by the detection-and-calculation device 230 according to the preferred embodiment.

Please refer to the following exemplars: As shown in FIG. 3 and FIG. 4, the pixel pitch “i” of the display panel 210 is 0.1 millimeter (mm) in and the first distance “g” between the display panel 210 and the parallax barrier 220 is 1.15 mm in the preferred embodiment, which are all predetermined and fixed. When different second distances “z” between the observer and the display panel 210 are detected by the detection-and-calculation device 230, different ideal barrier pitches “bᵢ” are obtained according to formula (1), as shown in Table 1:

TABLE 1

| bi | i | z | g |
|---|---|---|---|
| 0.1996933 | 0.1 | 750 | 1.15 |
| 0.19954 | 0.1 | 500 | 1.15 |
| 0.199425 | 0.1 | 400 | 1.15 |

unit: mm

According to the different ideal barrier pitches “bᵢ” that are suited for different second distances “z”, the rotary stepping motor 244 of the parallax barrier adjustment device 240 is used to select a barrier region that has the barrier pitch “b” equal to the ideal barrier pitch “bᵢ” from the parallax barrier 220 by rotating the roll 242. As shown in FIG. 3, when the second distance “z” is exemplarily 750 mm, the rotary stepping motor 244 and the roller 242 select a proper barrier region such as the first barrier region 2201 having the barrier pitch “b₁” of 0.1996933 mm, that is equal to the ideal barrier pitch “bᵢ”, from the first barrier region 2201 to the Nth barrier region 220N of the parallax barrier 220. Therefore, the observer obtains the stereoscopic images at said viewing distance. In another exemplar as shown in FIG. 4, when the second distance “z” is exemplarily 400 mm, the rotary stepping motor 244 and the roller 242 selects another proper barrier region such as the barrier region 2203 having the barrier pitch b₃ of 0.199425 mm that is equal to the ideal barrier pitch “bᵢ” from the first barrier region 2201 to the Nth barrier region 220N of the parallax barrier 220. Therefore, the observer still obtains the stereoscopic images at said viewing distance.

According to the stereoscopic image displaying method and the stereoscopic display device of the first preferred embodiment, different viewing distances are obtained by providing different barrier regions having different barrier pitches. When the observer increases or reduces the viewing distance, the detection-and-calculation device of the stereoscopic display device of the present invention is utilized to detect the second distance “z” (the real viewing distance) between the observer and the display panel 210, and thus an ideal barrier pitch “bᵢ” is obtained. Accordingly, a proper barrier region is selected from the first barrier region 2201 to the Nth barrier region 220N of the parallax barrier 220 by the parallax barrier adjustment device 240. In other words, the parallax barrier adjustment device 240 is used to select a proper barrier pitch that is equal to the ideal barrier pitch “bᵢ”, from the first barrier pitch “b₁” to the Nth barrier pitch “bₙ”. Briefly speaking, when the observer increases or reduces the real viewing distance, the stereoscopic image displaying method and the stereoscopic display device of the first preferred embodiment always provides 3D stereoscopic images of high quality by providing a proper barrier region suited for the real viewing distance.

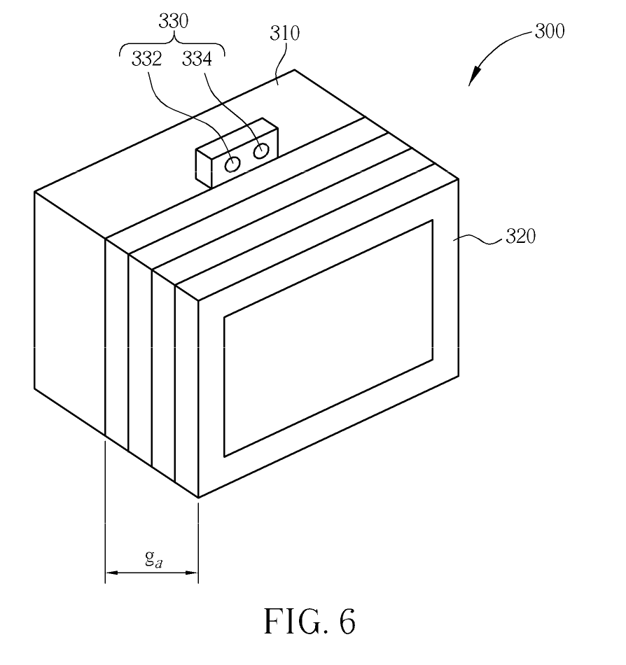

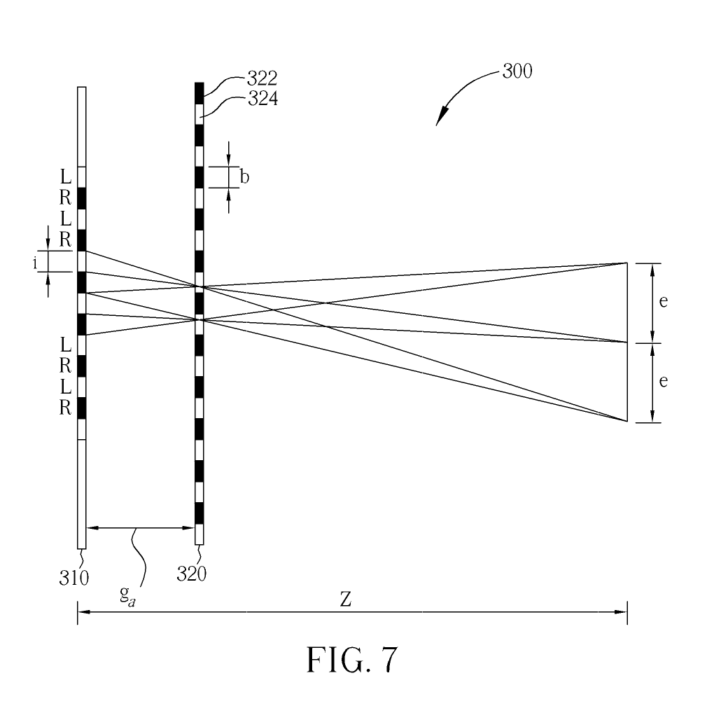

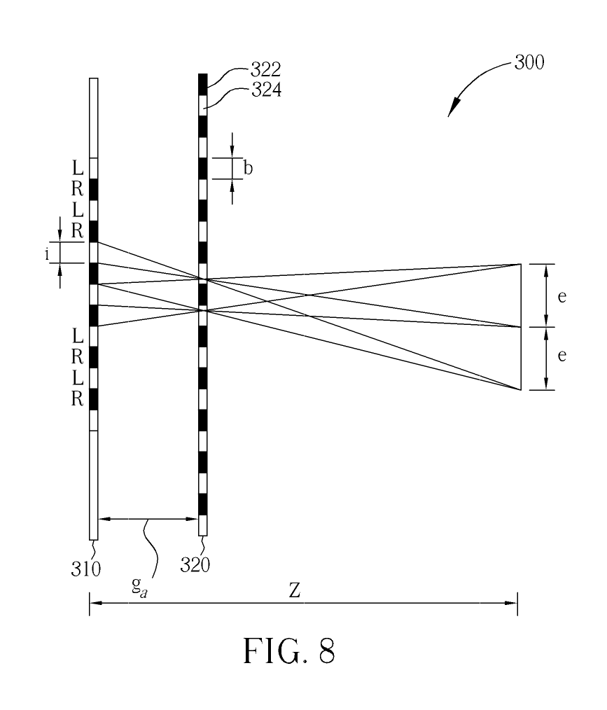

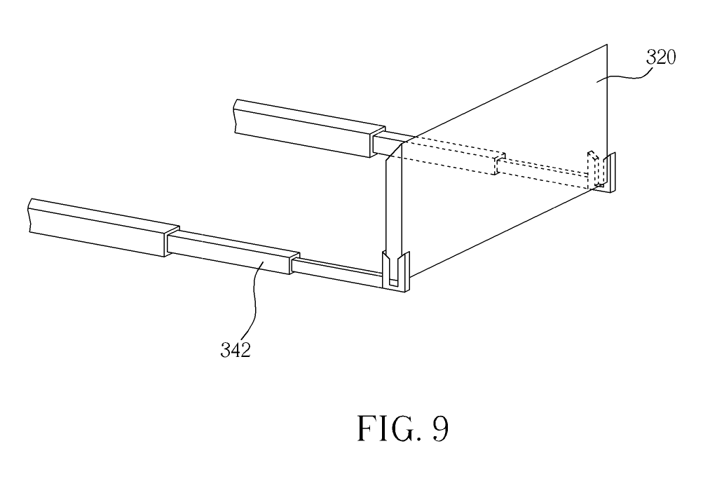

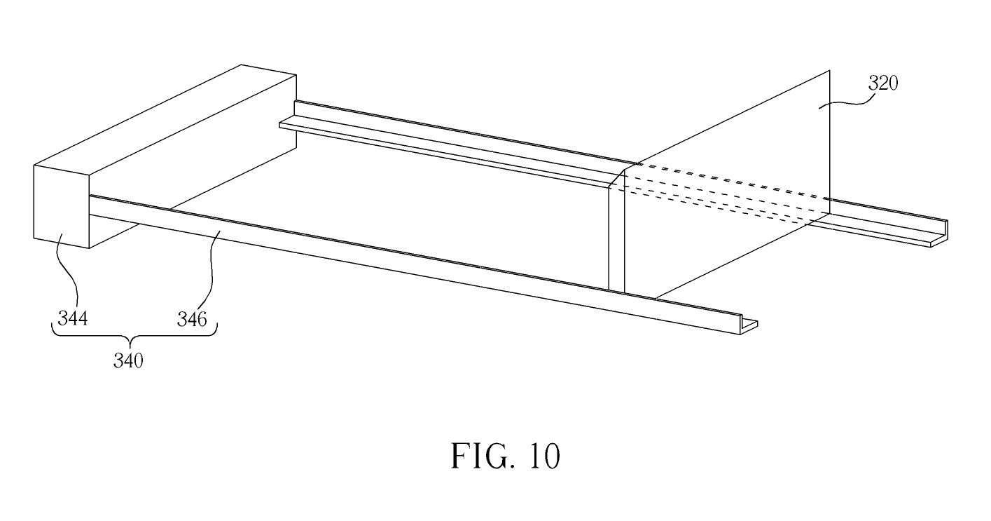

Please refer to FIGS. 6-10, wherein FIG. 6 is a schematic drawing illustrating a stereoscopic image displaying method and a stereoscopic display device provided by a second preferred embodiment of the present invention, FIGS. 7-8 are schematic drawings illustrating different optical paths of the preferred embodiment in different operations, and FIGS. 9-10 are schematic drawings illustrating modifications to the preferred embodiment. As shown in FIG. 6, a stereoscopic display device 300 having a display panel 310 and a backlight module (not shown) is provided by the preferred embodiment. The display panel 310 provides an image, and the image is divided into a left eye image L and a right eye image R (shown in FIG. 7 and FIG. 8) according to the preferred embodiment. The left eye image L and the right eye image R respectively have a pixel pitch “i” formed therebetween. The stereoscopic display device 300 further includes a parallax barrier 320 constructed by a plurality of shading regions 322 and a plurality of transparent regions 324 in stripe patterns (shown in FIG. 7 and FIG. 8). More important, the stereoscopic display device 300 includes an adjustable first distance “gₐ” between the parallax barrier 320 and the display panel 310. The parallax barrier 320 is positioned in front of the display panel 310. However, it is not limited to position the parallax barrier 320 between the display panel 310 and the backlight module in the present invention.

Please still refer to FIG. 6. The stereoscopic display device 300 of the preferred embodiment also includes a detection-and-calculation device 330. The detection-and-calculation device 330 is used to detect a second distance “z”, that is the viewing distance, between the display panel 310 and an observer. The detection-and-calculation device 330 includes at least a computing circuit (not shown), a distance meter 332, and an image device 334. The distance meter 332 can be an infrared distance meter or a Laser distance meter, but not limited to this. The image device 334 can be a charge coupled device but not limited to this. The distance meter 332 is used to detect the second distance “z” between the observer and the display panel 310 and the image device 334 is used to detect a third distance “e” between two eyes and a center of the two eyes of the observer. Additionally, the third distance “e” is a detected value in the preferred embodiment, but it also can be a predetermined value.

According to the stereoscopic image displaying method of the preferred embodiment, the display panel 310 and the parallax barrier 320 is provided. Then, the distance meter 332 and the image device 334 of the detection-and-calculation device 330 are used to detect the second distance “z” between the display panel 310 and the observer and the third distance “e” between the two eyes and the center of the two eyes of the observer. After obtaining the second distance “z” and the third distance “e” from the distance meter 332 and the image device 334, the computing circuit is operated to obtain an ideal first distance “gᵢ” according to a formula (2):

$$z = g ( \frac{e + i}{i} ) \qquad ( 2 )$$

According to the formula (2), it is found the first distance “g” is always corresponding to the second distance “z” and the third distance “e” because the pixel pitch “i” is predetermined and fixed. In other words, ideal first distances “gᵢ” suited for different second differences “z” and different third distances “e” are obtained by the detection-and-calculation device 330 according to the preferred embodiment.

As shown in FIG. 7 and FIG. 8, the pixel pitch “i” of the display panel 310 is 0.1 mm in the preferred embodiment. In an exemplar, the third distance “e” between the two eyes and the center of the two eyes of the observer can be 75 mm or 50 mm in the preferred embodiment. When different second distances “z” are detected by the detection-and-calculation device 330, different ideal first distance “gᵢ” are obtained according the abovementioned formula (2), as shown in Table 2:

TABLE 2

| e | i | z | gᵢ |
|---|---|---|---|
| 75 | 0.1 | 750 | 0.998668 |
| 75 | 0.1 | 500 | 0.665779 |
| 75 | 0.1 | 400 | 0.532623 |
| 50 | 0.1 | 750 | 1.497006 |
| 50 | 0.1 | 500 | 0.998004 |
| 50 | 0.1 | 400 | 0.798403 |

Unit: mm

The stereoscopic display device 300 of the present invention further includes a parallax barrier distance adjustment device 340. (shown in FIG. 9 and FIG. 10) According to different second distances “z” and different third distances “e” detected by the detection-and-calculation device 330, different ideal first distance “gᵢ” are obtained. Consequently, the adjustable first distance “gₐ” between the parallax barrier 320 and the display panel 310 is adjusted to be equal to the ideal first distance “gᵢ” by the parallax barrier distance adjustment device 340. Therefore the observer positioned at different second distances “z” still obtains 3D stereoscopic images. As shown in FIG. 7, when the detected second distance “z” is exemplarily 750 mm and the detected third distance “e” is exemplarily 75 mm, the parallax barrier distance adjustment device 340 as shown in FIG. 9 and FIG. 10 is utilized to adjust the adjustable first distance “gₐ” to 0.998668 mm, that is equal to the ideal first distance “gᵢ”. Therefore the observer obtains the stereoscopic images at said viewing distance. In another exemplar as shown in FIG. 8, when the detected second distance “z” is exemplarily 400 mm and the detected third distance “e” is exemplarily 50 mm, the parallax barrier distance adjustment device 340 is utilized to adjust the adjustable first distance “gₐ” to 0.798403 mm, that is equal to the ideal first distance “gᵢ”. Therefore the observer still obtains stereoscopic images at said viewing distance.

Please refer to FIG. 9 and FIG. 10, the parallax barrier distance adjustment device 340 of the stereoscopic display device 300 can be a telescoping tube 342 as shown in FIG. 9. When setting up the stereoscopic display device 300, the working staff adjusts the telescoping tube 342 to make the adjustable first distance “gₐ” equal to the ideal first distance “gᵢ” that is obtained by the detection-and-calculation device 330. Furthermore, the barrier distance adjustment device 340 can include a stepping motor 344 and a track 346 with the parallax barrier 320 connected to the stepping motor 344 and positioned on the track 346 as shown in FIG. 10. Every time when the stereoscopic display device 300 is turned on, the second distance “z” and the third distance “e” are detected by the detection-and-calculation device 330 and thus the ideal first distance “gᵢ” is obtained. Consequently, the stepping motor 344 is used to adjust the parallax barrier 320 positioned on the track 346 to make the adjustable first distance “gₐ” between the parallax barrier 320 and the display panel 310 equal to the ideal first distance “gᵢ”. Accordingly, the observer always obtains stereoscopic images in different second distances “z”.

According to the stereoscopic image displaying method and the stereoscopic display device of the second preferred embodiment, different viewing distances are obtained by adjusting the adjustable first distance “gₐ”: when the observer increases or reduces the real viewing distance, the detection-and-calculation device 330 of the stereoscopic display device of the present invention is utilized to detect the second distance “z” (the real viewing distance) between the observer and the display panel 310, and thus an ideal first distance “gᵢ” is obtained. Subsequently, the parallax barrier adjustment device 340 is used to adjust the adjustable first distance “gₐ” to be equal to the ideal first distance “gᵢ”. Briefly speaking, when the observer increases or reduces the real viewing distance, the stereoscopic image displaying method and the stereoscopic display device of the first preferred embodiment still provides 3D stereoscopic images of high quality. Briefly speaking, when the observer increases or reduces the real viewing distance, the stereoscopic image displaying method and the stereoscopic display device of the second preferred embodiment always provides 3D stereoscopic images of high quality by providing a proper adjustable first distance “gₐ” suited for the real viewing distance.

According to the stereoscopic image displaying method and the stereoscopic display device provided by the present invention, different viewing distances are obtained by providing barrier regions having different barrier pitches or by providing different distances between the parallax barrier and the display panel. Therefore, when the observer increases or reduces the real viewing distance, the stereoscopic image displaying method and the stereoscopic display device provided by the present invention always provide 3D stereoscopic images of high quality.

Those skilled in the art will readily observe that numerous modifications and alterations of the device and method may be made while retaining the teachings of the invention.

What is claimed is:

1. A stereoscopic image displaying method comprising:
providing a display panel having a pixel pitch for displaying an image;
providing a parallax barrier having a first barrier region to an Nth barrier region and a first distance between the parallax barrier and the display panel, the first barrier region to the Nth barrier region respectively having a first barrier pitch to a Nth barrier pitch;
providing a second distance between the display panel and an observer; and
selecting a proper barrier region from the first barrier region to the Nth barrier region of the parallax barrier according to the second distance.

2. The stereoscopic image displaying method of claim 1, wherein the step of selecting a proper barrier region from the parallax barrier according to the second distance satisfies the following formula (1):
$$b = 2 i ( \frac{z - g}{z} ) \qquad ( 1 )$$
Wherein b is a barrier pitch, i is the pixel pitch, g is the first distance, and z is the second distance.

3. A stereoscopic image displaying method comprising:
providing a display panel having a pixel pitch for providing an image;
providing a parallax barrier and a first distance between the parallax barrier and the display panel;
providing a second distance between the display panel and an observer and a third distance between two eyes and a center of the two eyes of the observer; and
adjusting the first distance according to the second distance and the third distance.

4. The stereoscopic image displaying method of claim 3, wherein the step of adjusting the first distance according to the second distance and the third distance satisfies the following formula (2):
$$z = g ( \frac{e + i}{i} ) \qquad ( 2 )$$
wherein i is the pixel pitch, g is the first distance, z is the second distance, and e is the third distance.
